(19) United States
(12) Patent Application Publication
(10) Pub. No.: US 2020/0068369 A1
(43) Pub. Date: Feb. 27, 2020

(54) IOT SERVICE SYSTEM WITH BLUETOOTH LOW ENERGY MESH NETWORK, AND COMMUNICATION METHOD THEREOF

(71) Applicant: Keenstar Corporation, Taipei City (TW)

(72) Inventors: LI-WEN LIAO, Taipei City (TW); JINN-YUAN LAY, Taipei City (TW); YEN-TING HO, Taipei City (TW); WAN-CHEN CHEN, Taipei City (TW)

(21) Appl. No.: 16/112,932

(22) Filed: Aug. 27, 2018

(51) Int. Cl. H04W 4/70; H04W 4/02; H04W 4/029; H04W 4/06; H04W 4/80

(52) U.S. Cl. CPC H04W 4/70; H04W 4/023; H04W 84/18; H04W 4/06; H04W 4/80; H04W 4/029

(57) ABSTRACT

The disclosure is related to an IoT service system with a Bluetooth Low Energy mesh network, and a communication method thereof. The IoT service system includes multiple intelligent service calling devices, multiple service communication devices and an agent node forming a BLE mesh network. One service calling device generates a service request signal that is broadcasted over a BLE mesh network. When a server receives the service request signal through the agent node, a service personnel and his portable service communication device are obtained by querying a database according to identification information relating to the service calling device that generates the service request signal. A service calling signal is therefore formed and broadcasted over the BLE mesh network. If a distance between the service communication device and the service calling device reaches a threshold while the service personnel is in service, a service dismissing signal is generated.

### FIELD OF THE DISCLOSURE

The disclosure is related to a service system that adopts an IoT communication technology, more particularly to an IoT service system with a Bluetooth Low Energy mesh network, and a communication method thereof.

### BACKGROUND OF THE DISCLOSURE

Advancement in communication technology drives the development of the Internet of Things (IoT). The development of IoT is reflected in applications such as sensors disposed at various locations of a place. With those sensors, users can be made aware of certain events that occur in the place. For example, information related to temperature, electricity and light of the place can be acquired through the sensors, so that follow-up procedures, i.e., measures that are executed according to the information acquired by the sensors, can be performed. One of the characteristics of an IoT service system for every terminal is that a network connection for transmitting or receiving data need be maintained at all times. It is necessary for the terminals of the IoT service system to use a low-power consumption communication technology since the applications of IoT consume too much power. Further, a communication technology, such as a Bluetooth™ Low Energy (Bluetooth LE, Colloquially ‘BLE’), is required in this system when the terminals of the IoT service system are widely distributed over the site. It should be noted that BLE is intended to provide considerably reduced power consumption while maintaining a wireless communication range that can be applied to communication requirement among the nodes in the system.

The device with IoT characteristics usually drives an automatic procedure that can be applied at a site requiring service such as a bank, a restaurant or a mall. For example, a motion sensor can be disposed at an entry of the site. A ringtone or a voice message can be generated to notify a service personnel to provide service when the motion sensor senses any person entering the site.

However, among conventional IoT applications, seldom is there one with a mechanism to interact with a customer who enters the site, since the follow-up procedure driven by the IoT device is not combined with any service procedures.

### SUMMARY OF THE DISCLOSURE

The disclosure is related to an IoT service system with Bluetooth Low Energy (Colloquially ‘BLE’) mesh network and a communication method thereof. The BLE mesh network is characterized in that it is a low power communication technology that can provide the IoT service system with an extended operational time. Further, the topology of mesh network expands a service range of the IoT service system for allowing every node of the system to fully perform its function.

In one embodiment of the disclosure, the IoT service system with BLE mesh network essentially includes a server, a plurality of service communication devices carried by service personnels, and a plurality of intelligent service calling devices disposed at many service locations. The plurality of service communication devices and intelligent service calling device act as the multiple nodes of the BLE mesh network.

In the communication method, both the service communication device and the communication circuit of the intelligent service calling device generate the packets in compliance with the Bluetooth Low Energy communication protocol and also support a mechanism with short pieces of data and of turning off the circuit when in idle state.

When one of the intelligent service calling devices generates a service request signal under the Bluetooth Low Energy communication protocol, the service request signal is broadcasted via the Bluetooth Low Energy mesh network. After the server receives the service request signal, a software sequence running in the server starts querying a service personnel database according to identification information carried in the signal. A service personnel and his service communication device with respect to the identification information can be obtained. A service calling signal is accordingly generated. The calling information carries information relating to the intelligent service calling device that generates the service request signal. The service calling signal is broadcasted via the Bluetooth Low Energy mesh network, and then the service communication device carried by the service personnel receives the service calling signal.

The service personnel then arrives at the location where the service request signal is generated. When a distance between the service communication device and the intelligent service calling device reaches a threshold, the service communication device or the intelligent service calling device generates a service dismissing signal that is also broadcasted via the Bluetooth Low Energy mesh network. The server then receives the service dismissing signal.

In one further embodiment, in the IoT service system, the server can join the Bluetooth Low Energy mesh network directly or through an agent program that is executed in a node. Any message generated by the server can be transmitted through the agent program.

Furthermore, the service personnel database records a plurality of service locations corresponding to identification information of the intelligent service calling devices, and calling information that can be a communication ID of a service communication device carried by a service personnel. For a specific service location, a service order with respect to a plurality of service personnels may be provided.

Thus, according to the service order, the server will broadcast a service calling signal to a service personnel that is first in order. If the service communication device carried by the first service personnel issues a rejection signal, the server issues the service calling signal to a service personnel that is next in order. It should be noted that the signals are broadcasted via a Bluetooth Low Energy mesh network.

When the server issues the service calling signal to the first service personnel in order, or the server acknowledges that the service personnel has already received the service calling signal, the server starts a timer. If the server does not receive the service dismissing signal when the time reaches a time threshold, the server re-issues the service calling signal to a next service personnel.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings, in which:

FIG. 1 shows a schematic diagram of an IoT service system with Bluetooth Low Energy mesh network according to one embodiment of the disclosure;

FIG. 2 shows a schematic diagram depicting the functional blocks of the IoT service system applying a Bluetooth Low Energy mesh network and a communication method thereof according to one embodiment of the disclosure;

FIG. 3 shows a flow chart describing the communication method of the IoT service system in one embodiment of the disclosure;

FIG. 4 shows a schematic diagram describing the IoT service system with Bluetooth Low Energy mesh network according to one of the embodiments of the disclosure;

FIG. 5 shows another schematic diagram describing the IoT service system according to one further embodiment of the disclosure;

FIG. 6 shows a flow chart describing the communication method of the IoT service system according to one embodiment of the disclosure;

FIG. 7 shows one further flow chart describing the communication method of the IoT service system according to one further embodiment of the disclosure; and

FIG. 8 shows a flow chart describing the communication method of the IoT service system according to one embodiment of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The disclosure is related to an IoT service system with a Bluetooth Low Energy (BLE) mesh network, and a communication method thereof. The BLE mesh network develops a communication technology among a plurality of nodes in a mesh network. In one embodiment, the end devices of an IoT (Internet of Things) form the nodes of the mesh network. The node may act as a broadcaster, an observer or both in the mesh network. The broadcaster node acts as a specific number of channels, e.g. 3 channels, provided for broadcast packets. The receiver then receives the broadcast packets via the channels.

The communication technology applied to the nodes in the Bluetooth Low Energy mesh network is based on Bluetooth™ technology. Under BLE mechanism, the electronic elements of the node are in idle state except for receiving or transmitting signals, and the number of the broadcast channels is substantially reduced until they are woken up to process the signals. Further, the BLE technology also allows the node to optimize its power consumption by flexibly adjusting the length of data and reducing the number of times of receiving and transmitting the data according to the length of data.

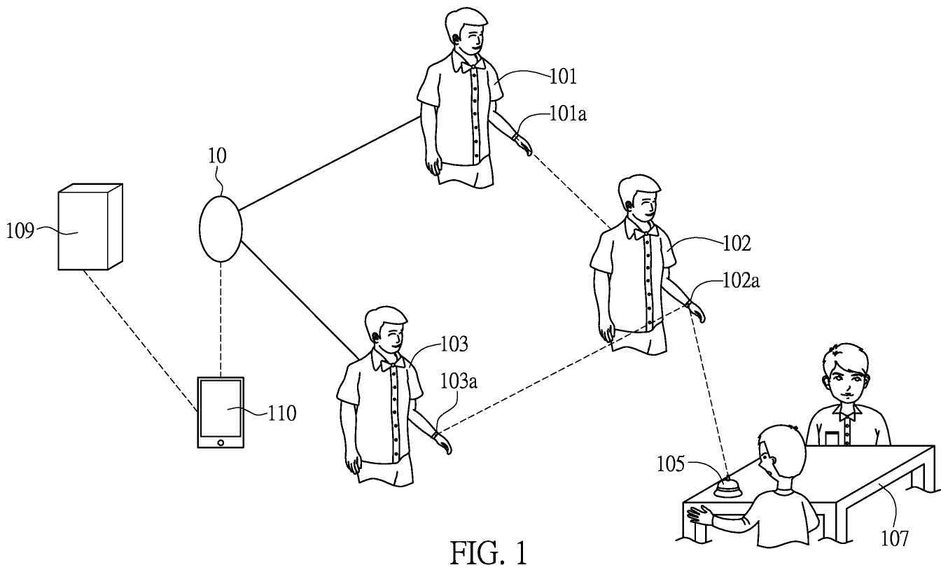

The framework of the IoT service system with the BLE mesh network can be referred to in the diagram shown in FIG. 1. The IoT service system is applied to a site that is required to provide service to customers. For example, the system can be applied in a bank, a shopping mall, a restaurant, a healthcare center, an airplane, a cruise ship, or a place in need of security service. When any person enters the site, the person can trigger an intelligent service calling device to summon a service personnel to the customer's location for providing service. The intelligent service calling device is such as a service bell, a touch-sensitive device or a computer device that is capable of delivering messages. A server of the site will inform the service personnel who is near the location of the intelligent service calling device or is in charge of serving the area to arrive at the service location based on the location of the intelligent service calling device.

In one embodiment of the disclosure, the IoT service system includes a server host 109, a service management device 110, an agent node 10 that can be implemented by any node of the system, an client-end intelligent service calling device 105 and a plurality of portable devices 101a, 102a, 103a carried by waiters 101, 102 and 103. The intelligent service calling device 105 and the service communication devices, e.g. the portable devices 101a, 102a and 103a, form the essential elements of a Bluetooth Low Energy mesh network. In one aspect of the system, the agent node 10 may also be part of the mesh network. The portable device on the waiter 101, 102 or 103 can be a mobile phone, a tablet computer, smart glasses, or other types of portable devices. The service management device 110 that is connected to a server host 109 is integrated into the Bluetooth Low Energy mesh network by the server host 109 itself or through the agent node 10. That means the server host 109 can directly controls the operations of the BLE mesh network. The service management device 110 acts as a device controlled by an administrator within the site that provides service. The service management device 110 may be a computer-implemented Point of Sales (POS), and is not limited to any particular type of computer device.

The server host 109 can be a standalone computer host or a software process embedded in a terminal device capable of data processing or the POS operated at a business site. For example, as the standalone computer host, the server host 109 may not connect with the intelligent service calling device 105 and the portable devices 101a, 102a and 103a within the Bluetooth Low Energy mesh network directly, but through the agent node 10. Further, the computer host, the server host 109 can still connect with the intelligent service calling device 105 and the portable devices 101a, 102a and 103a directly in one further aspect of the invention. It should be noted that the intelligent service calling device 105 can be, but is not limited to being, a service bell. The portable device (101a, 102a or 103a) can be any kind of service communication device worn by the waiter.

In the mentioned site that is required to provide service to customers, a mechanism of responsibility and accountability is introduced among the waiters. Under the mechanism, every waiter is responsible for the customers in a specific area or to the specific clients. The mechanism of responsibility and accountability can be controlled by a software sequence running in the server host 109. The waiters can be assigned to be responsible for different events, different areas or different locations. A job substitute can also be set for each waiter that is configured according to a service order including multiple service personnels with overlapping areas of responsibility. When any service personnel who is responsible for a specific area indicates that he is unable to provide service, the system will automatically calling upon his job substitute to provide the service according to the service order calling.

The IoT service system shown in FIG. 1 integrates hardware and software. The terminal devices are communicated with each other via the Bluetooth Low Energy mesh network. In an exemplary example, the IoT service system is applied at a site with a plurality of service locations that are disposed with a plurality of intelligent service calling devices 105. In the diagram, several customers are at a service location 107 that is such as a table or specific location in a restaurant. The nearby intelligent service calling device 105 can be a service bell, a device for ordering, or a computer device with display function.

A server running in the server host 109 can communicate with the intelligent service calling device 105 and the portable devices 101a, 102a and 103a directly or via the agent node 10. The service management device 110 can be incorporated for accessing the server host 109. A technology of Bluetooth Low Energy communication protocol (colloquially ‘BLE’) is applied to the system for forming the Bluetooth Low Energy mesh network. A processing unit of the server host 109 executes a software program stored in a memory of the host. A message issued by the server host 109 can be transmitted through the agent node 10 over the Bluetooth Low Energy mesh network having the intelligent service calling device 105 and the portable devices 101a, 102a and 103a.

In the present embodiment, a customer at the service location 107 issues a service request signal via the intelligent service calling device 105. The service request signal records identification information (ID) corresponding to the intelligent service calling device 105. The service request signal is broadcasted to a destination, e.g. the server host 109, via the Bluetooth Low Energy mesh network. The signal is delivered among the intelligent service calling device 105 and the portable devices 101a, 102a and 103a, and finally to the server host 109 directly or via the agent node 10. A service location 107 corresponding to the service request signal can be obtained by querying a database of the server host 109 according to the identification information. A software sequence running in the server host 109 receives the service request signal via the LAN 10. After querying a service personnel database according to the identification information, one or more waiters 101, 102 and 103 corresponding to the service location 107 can be obtained. The calling information such as the communication IDs relating to the portable devices 101a, 102a, 103a worn by the waiters 101, 102, 103 can therefore be obtained. The communication ID can be an IP address, a number, or a MAC address. The server host 109 broadcasts a service calling signal through the agent node 10 via the Bluetooth Low Energy mesh network. The broadcast messages are delivered via all or part of the portable devices 101a, 102a and 103a, and finally reach the portable device carried by the waiter.

The waiter who receives the service calling signal goes to the service location 107 for providing service. In one embodiment, when a distance between the service communication device, i.e. one of the portable devices (101a, 102a, 103a) and the intelligent service calling device 105 that generates the service request signal, reaches a threshold, the portable device or the intelligent service calling device 105 generates a service dismissing signal. The service dismissing signal is transmitted to the server host 109 through the agent node 10 via the Bluetooth Low Energy mesh network, thus ending the service calling procedure.

In one further embodiment, the intelligent service calling device 105 can be disposed in a restaurant kitchen. The identification information of the intelligent service calling device 105 corresponds to the location of the kitchen. When the intelligent service calling device 105 in the kitchen generates the service request signal with a service location and a time limit where and when a chef indicates that a dish should be served, a service calling sequence running in the server host 109 starts a timer. The service calling sequence also determines that the kitchen is ready to serve the dish and obtains the service location. The service calling signal is broadcasted to one or more service personnels according to the service personnel table in a database via the BLE mesh network. The server host 109 then asks for the service personnel to come to the kitchen for serving the dish to the service location within the time limit. It should be noted that the service location indicated by the chef is such as a table number.

The software sequence running in the server host 109 sets up a notification and reminding function, by which the system reminds the service personnel to provide service within a time limit when a customer arrives at the service location through the server host 109. Furthermore, the server host 109 can also notify the service personnel to remind the customer the message such as a table time limit, a closing time, a special offer or a special event.

In addition to issuing the service calling signal to the service personnel according to the service personnel table, the server host 109 can issue a message to all or part of the service personnels under a specific event. For example, the intelligent service calling procedure running in the server host 109 can issue all or part of the service personnel with certain general messages, e.g. certain dishes have been sold out, a new dish proposition, a new offer, the closing time, equipment inspection, and taking inventory, via the BLE mesh network.

In one aspect of the invention, the software-based server can also be embedded into a portable device or an intelligent service calling device if such terminals are capable of handling a certain level of signal processing and memory.

Under the BLE communication protocol, when an initial device broadcasts a message to one or more devices via the BLE mesh network, the IoT-like device that receives the broadcasted message continuously broadcasts the message according a destination recorded in the message. A non-destination device will continuously broadcast the received message without recording the message. The targeted device performs the task recorded in the message when receiving the message.

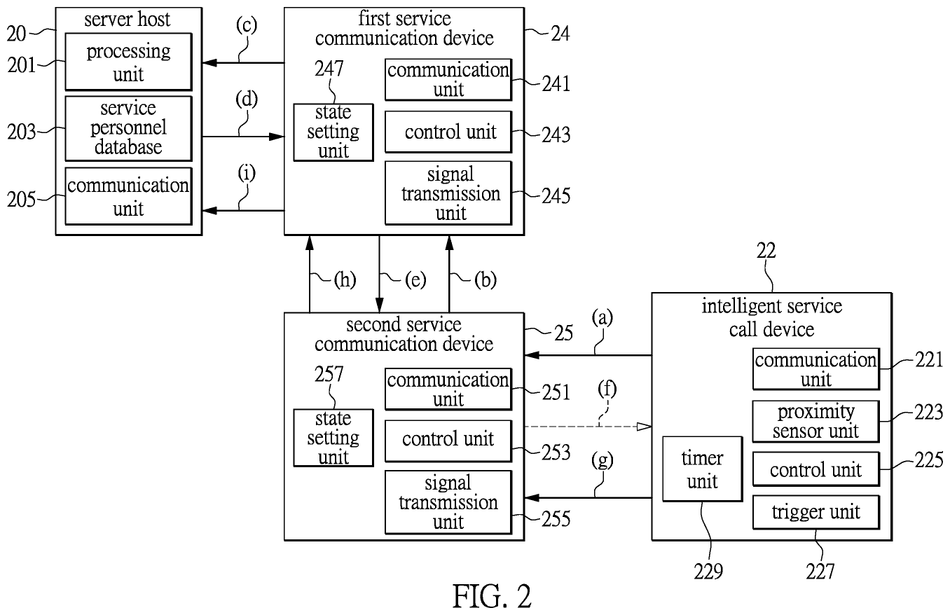

FIG. 2 next shows a schematic diagram depicting the electrical elements of the devices of the IoT service system. A server host 20 shown in the diagram implements a server of the system. The essential elements of the server include a processing unit 201, a service personnel database 203 and a communication unit 205. The main elements of the intelligent service calling device 22 include a communication unit 221, a proximity sensor unit 223, a control unit 225, a trigger unit 227 and a timer unit 229. Both a first service communication device 24 and a second service communication device 25 carried by the service personnels have control units (243, 253) and other elements electrically connected with the control units (243 and 253). The other elements are essentially communication units (241, 251), signal transmission units (245, 255) and status setting units (247, 257).

In one aspect, the server host 20 (optionally through an agent node), the intelligent service calling device 22 and the service communication devices (24, 25) form the nodes in the Bluetooth Low Energy mesh network. The communication units (205, 221, 241, and 251) of these nodes are able to process the packets in compliance with the BLE communication protocol, and also support a mechanism with short pieces of data and of turning off the circuit when in idle state. The device supporting BLE communication protocol requests a connection only at times when messages are required to be transmitted or received, as compared with the traditional Bluetooth™ communication protocol that requires frequent pairing or scanning with other devices.

The control unit 225 of the intelligent service calling device 22 can be a micro-controller that is used to process a triggered service event. The service event is triggered to generate a service request signal. A distance between the service communication device (first service communication device 24 or second service communication device 25) carried by the service personnel and the intelligent service calling device 22 is calculated according to a received signal strength. The service request can be dismissed when a condition is met.

In one further embodiment, the intelligent service calling device 22 has a trigger unit 227 that can be a service bell, a touch button or any other method to trigger a service calling. For example, a voice command can be used to generate the service request signal. More specificallingy, the trigger unit 227 is electrically connected with the control unit 225, and used to generate the service request signal through the control unit 225.

The communication unit 221 of the intelligent service calling device 22 is electrically connected with the control unit 225. The communication unit 221 performs the BLE communication protocol. When the server host 20 is the destination, the communication unit 221 transmits the service request signal via a broadcast scheme when packaging the destination in the signal. The signal firstly arrives at the second service communication device 25 (step (a)). The second service communication device 25 then continuously broadcasts the signal to the first service communication device 24 (step (b)). The first service communication device 24 continues broadcasting the service request signal and finally reaches the server host 20 (step (c)), or via an agent node according to one embodiment. The sequence running in the server host 20 can obtain calling information of one or more service personnels corresponding to the identification information in the service request signal.

The server host 20 then generates a service calling signal. The service calling signal is broadcasted (optionally via the agent code) via the BLE mesh network. The service calling signal can be broadcasted to the corresponding second service communication device 25 (step (d), step (e)). After that, the service personnel carrying the second service communication device 25 goes to the location of the intelligent service calling device 22 (step (f)).

The proximity sensor unit 223 of the intelligent service calling device 22 is such as an electrical element that conducts a specific near-end wireless communication protocol. The proximity sensor unit 223 is electrically connected with the control unit 225 and is used to calculate a distance between the service communication device (first service communication device 24 or second service communication device 25 and the intelligent service calling device 22.

In one exemplary example, the intelligent service calling device 22 periodicallingy broadcasts communication packets via the proximity sensor unit 223. The portable first service communication device 24 or second service communication device 25 carried by the service personnel can broadcast packets periodic calling. The proximity sensor unit 223 obtains a Received Signal Strength Indicator (RSSI) based on the receiving or transmitting of packets. RSSI is used to obtain the distance there-between. When the distance between the second service communication device 25 and the intelligent service calling device 22 reaches a distance threshold, the intelligent service calling device 22 or the second service communication device 25 carried by the service personnel generates a service dismissing signal. The Bluetooth Low Energy mesh network allows the system to broadcast and transmit data to the server host 20. A transmission process thereof to the server host 20 includes step (g), step (h), step (i).

In addition, a technology of Near Field Communication (colloquially NFC), Bluetooth™ communication or other kinds of near-end wireless communication technology can be incorporated between the intelligent service calling device 22 and the first service communication device 24 or the second service communication device 25. If a distance between the two devices reaches a distance threshold, the communication technology there-between allows the devices to exchange packets and to dismiss this service calling. In the meantime, a service dismissing signal is generated and broadcasted to the server host 20 via an agent node (not shown in this diagram) via the Bluetooth Low Energy mesh network.

The intelligent service calling device 22 has a timer unit 229 that is electrically connected with a control unit 225. When the customer issues the service request signal via the intelligent service calling device 22, the timer unit 229 is enabled to count the time. If there is no service personnel providing service when the time reaches a time threshold, the intelligent service calling device 22 re-issues the service request signal that reminds the system to send the service calling to the service personnel again.

The first service communication device 24 or the second service communication device 25 is such as an electronic device. A communication unit (241, 251) therein is able to process signals generated by the server host 20. The communication protocol running in the communication unit is preferably a Bluetooth Low Energy communication protocol that is used to generate the communication packets being exchanged with the intelligent service calling device 22. A signal transmission unit (245, 255) of the service communication device performs a specific communication protocol to exchange packets with the intelligent service calling device 22. An RSSI there-between can be used to calculate a distance. Further, both the first service communication device 24 and the second service communication device 25 have status setting units 247 and 257 that can be implemented by a physical button or a touch-sensitive element. The status setting units 247 and 257 are provided for the service personnel to set his status after receiving the service calling signal. For example, the service personnel can use the status setting units 247 and 257 to indicate that he can accept service callings since, e.g., he is currently near the service location, or that he will be rejecting service callings since he is currently busy. When the server host 20 receives an acceptance of a service by a service personnel calling, the BLE communication protocol is performed to generate a message for informing other service personnels who received the service calling signal. Otherwise, the server host 20 informs a service personnel that is next in order according to a service personnel table if the first service personnel is in a rejection status.

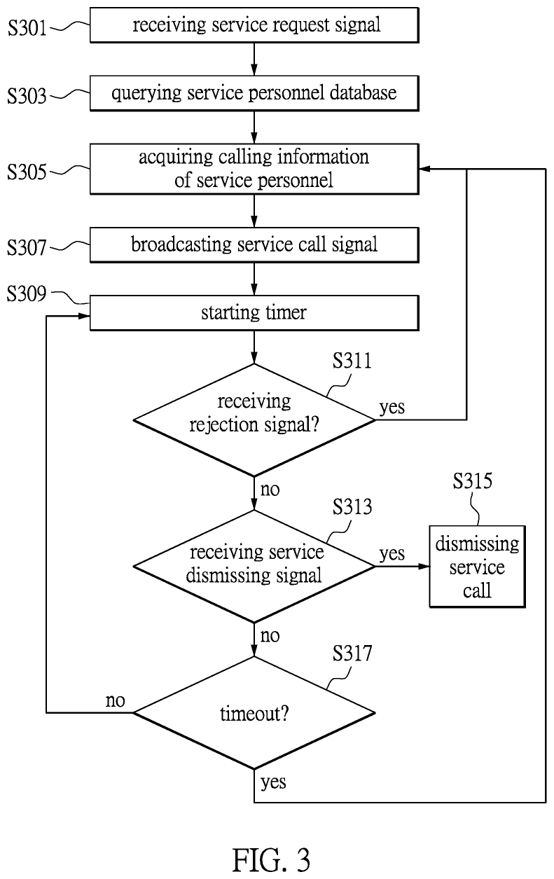

Reference is made to FIG. 3 showing a flow chart describing a communication method for an IoT service system. The IoT service system includes a one or more intelligent service calling devices and one or more service communication devices within the BLE mesh network.

In the beginning, such as in step S301, a software sequence operating in a server host or a server running in a specific terminal receives a service request signal generated by an intelligent service calling device. The service request signal complies with a BLE communication protocol and is broadcasted via a BLE mesh network. When the signal reaches the server (optionally via an agent node), the software sequence operating in the server resolves the signal and determines the signal as the service request signal, such as in step S303. The software sequence operating in the server gets identification information of the intelligent service calling device and accordingly obtains one or more service personnels and his/their job substitute corresponding to the service location by querying a service personnel database, such as in step S305. The server can also have calling information with respect to these service personnels. The calling information can be the communication ID of the service communication device carried by the service person. Using the communication ID, a service calling signal carrying the identification information of the intelligent service calling device that generates the present service request signal is generated.

In step S307, according to a service personnel table recording the job substitutes with respect to the service personnels, the server sets up a destination regarding a first service person, or more than one server person. The service calling signal is broadcasted to the destination, e.g. the service communication device carried by the first service person. In one further embodiment, the server is required to update the latest status of every service person. The status indicates whether the service personnel is on vacation, idle, in service, or in or out of service range. The status can also show the service person's service proficiency, his customer characteristics, items of service, whether or not a service has been dismissed, or the time already in service. The server can therefore make a comprehensive judgment so that calling various factors are taken into account before the service calling signal is transmitted to the first (available) service person.

After the server, via the agent node, broadcasts the service calling signal via the BLE mesh network, such as in step S309, the server starts a timer for this new service calling by resetting the previous time. The timer can be set with the same or different time limit with respect to the various items of service. In step S311, the server continues determining whether or not a rejection signal generated by any of the service communication devices is received within the time limit.

When the server receives the rejection signal via the agent node, the server goes on to repeat the step S305 for retrieving the calling information of the service person, the step S307 for transmitting the service calling signal to a next service personnel chosen with consideration to the status of service person, and step S309 for starting a new timer after setting up a new time limit, or continuing the previous timer.

If the server does not receive the rejection signal, the next step S313 is performed for determining whether or not a service dismissing signal is received from the intelligent service calling device or the service communication device. If the server receives the service dismissing signal within the time limit, it indicates that the service personnel has arrived at the service location. In step S315, the service calling is dismissed and the service calling is completed. Otherwise, if the server does not receive the service dismissing signal, the step S317 is performed to determine if it is timed out. If it is not timed out, the timers continue and the method goes to step S309 and repeats the subsequent steps such as the step S311 for determining whether or not the rejection signal is received, and the step S313 for determining whether or not the service dismissing signal is received. It should be noted that the service dismissing signal is broadcasted via the BLE mesh network.

If the process is timed out, it shows that no service personnel has arrived at the service location within the time limit. The process then repeats the previous steps for re-acquiring the next service person, re-issuing the service calling signal, restarting the timer and determining whether or not the service has been provided. It should be noted that the service personnel that is next in order may be a service personnel who was previously called.

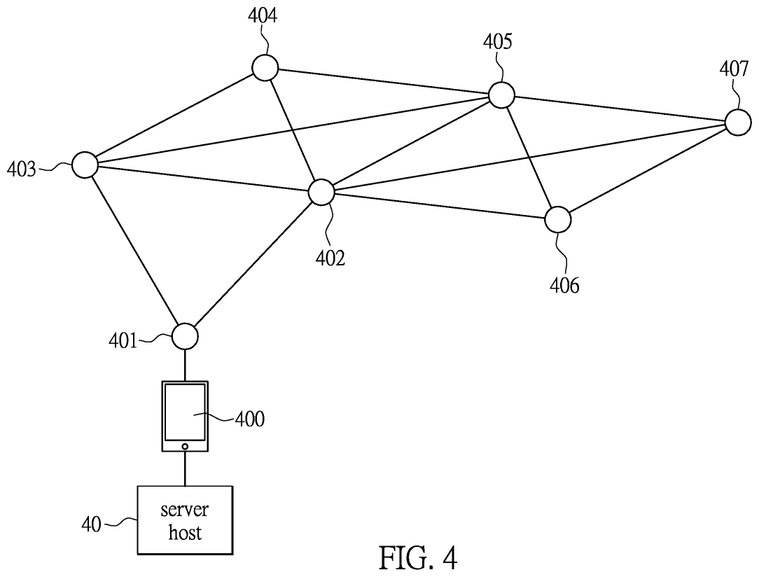

In the IoT service system applying the Bluetooth Low Energy mesh network of the disclosure, according to one embodiment shown in FIG. 4, the system essentially includes a server host 40, a service management device 400, and a plurality of IoT nodes 402, 403, 404, 405, 406 and 407. The IoT nodes exemplarily act as the abovementioned portable devices and the devices generating the service request signals. These nodes form a mesh network in compliance with Bluetooth Low Energy communication protocol.

Further, in one embodiment, the server host 40 can connect with the BLE mesh network directly or via an agent node 401 that performs an agent program. This agent node 401 can also be implemented by another node of the system. The agent node 401 allows the server host 40 to be integrated with the other nodes 402, 403, 404, 405, 406 and 407 so as to form one mesh network. In one embodiment, a service management device 400 can be provided in between the server host 40 and the agent node 401. The service management device 400 is used to manage operations of the nodes of the IoT service system. The service management device 400 can be such as a POS of a site.

Under the BLE communication protocol, the nodes can be communicated with each other by a broadcast scheme. For example, the node 407 generates a message and a destination is set to the server host 40. The message is broadcasted among the nodes 402, 403, 404, 405, 406 and 407 of the BLE mesh network. When the message reaches the agent node 401, the server host 40 gets the message and resolves the related information.

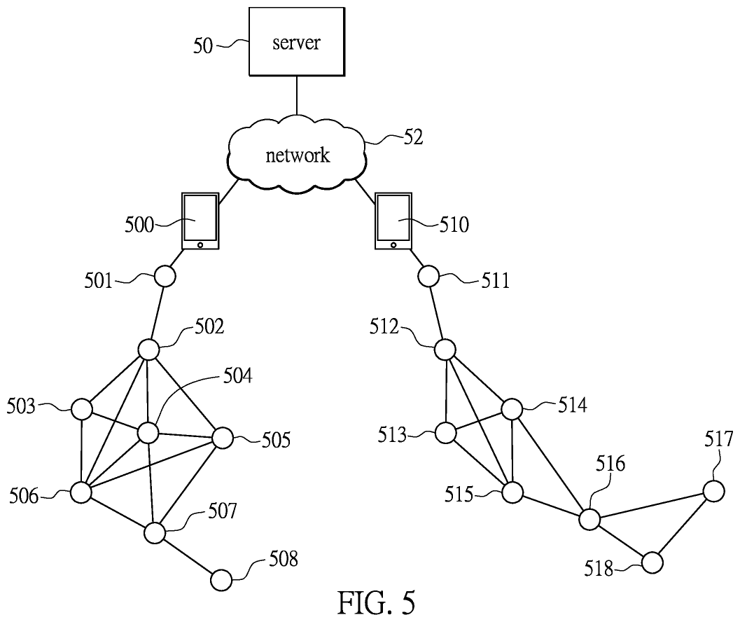

Reference is made to FIG. 5 depicting an IoT service system according to one of the embodiments of the disclosure. The server 50 communicates with the service management device 500, 510, and the nodes 501, 502, 503, 504, 505, 506, 507, 508, 511, 512, 513, 514, 515, 516, 517 and 518 via a network 52. These nodes constitute the IoT service system in compliance with the BLE communication protocol. The current example shows that there are two LANs within the IoT service system. The service management device 500 and the nodes 501, 502, 503, 504, 505, 506, 507 and 508 form a first mesh network. Further, the service management device 510 and the nodes 511, 512, 513, 514, 515, 516, 517 and 518 form a second mesh network. The BLE communication protocol allows these nodes including the service management device 500 to be communicated within their own LANs. It should be noted that the first mesh network and the second mesh network are two distinct network sections that are assigned with different IDs and ranges of IP addresses to avoid a mix up among the packets. The server 50 can simultaneously manage the messages transmitted in the two mesh networks via the respective agent nodes 501 and 511.

With an IoT service system used in a chain store as an example, the nodes 501, 502, 503, 504, 505, 506, 507, 508 and the service management device 500 disposed at one of the branches form the first mesh network; the nodes 511, 512, 513, 514, 515, 516, 517, 518 and the other service management device 510 at another branch form the second mesh network. The mentioned two branches are under the same system. The mentioned nodes can be service bells and electronic devices carried by the service personnels in the mesh network. When one of the nodes generates a service request signal, the service request signal carrying the node ID is broadcasted among the nodes of the mesh network. The service request signal then reaches the server 50 via the agent node (500 or 510), so that the server 50 can respond to this request.

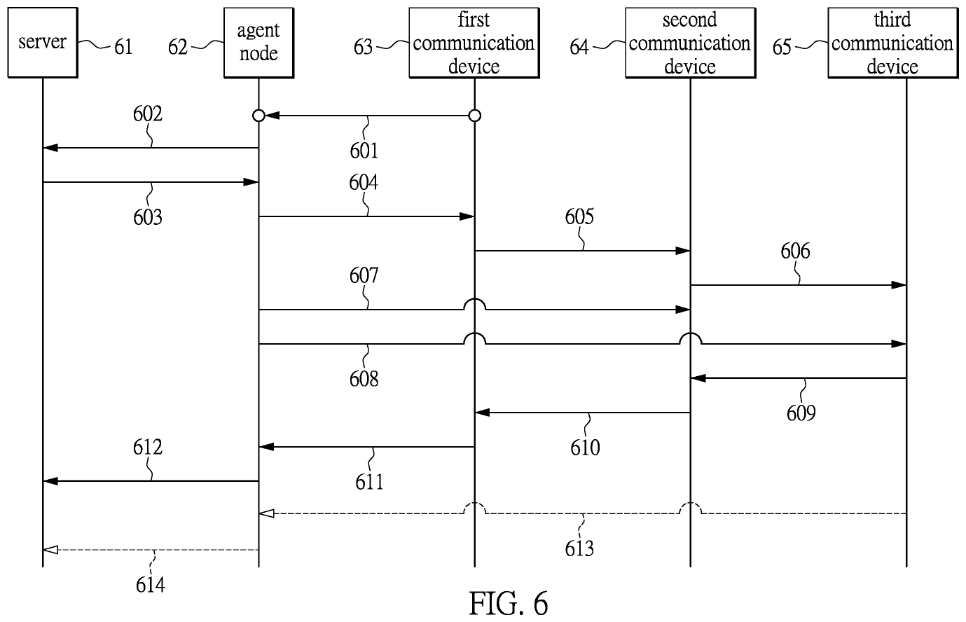

FIG. 6 to FIG. 8 show flow charts describing the communication method with Bluetooth Low Energy mesh network in several embodiments of the disclosure.

In FIG. 6, the IoT service system includes a server 61 and an agent node 62, and other nodes such as a first communication device 63, a second communication device 64 and a third communication device 65. It should be noted that the agent node 62 may be any node of the system or an agent program operating in one of the nodes. The agent node 62 and the communication devices (63, 64 and 65) are connected for forming a mesh network.

In the beginning, the first communication device 63 generates a service request signal that is broadcasted via the BLE mesh network under a BLE communication protocol. The agent node 62 receives the service request signal (step 601) and forwards the signal to the server 61 (step 602).

In the meantime, the server 61 acquires a service personnel according to the information resolved from the service request signal. In this example, the service personnel carries the third communication device 65. A service calling signal recording the third communication device 65 as the destination is generated (step 603). The service calling signal is converted to the packet in compliance with the BLE communication protocol by the agent node 62. The service calling signal is broadcasted via the BLE mesh network. In an exemplary example, the service calling signal reaches the third communication device 65 (step 606) specified as the destination through the first communication device 63 (step 604) and the second communication device 64 (step 605) in one broadcast path. In another broadcast path, the service calling signal can be broadcasted to the second communication device 64 directly (step 607), or to the third communication device 65 (step 608) directly.

When the third communication device 65 receives the service calling signal, the device can confirm a packet source and destination according to the information resolved from the signal. The third communication device 65 responds to the signal that is broadcasted via the mesh network. The exemplary broadcast path is through the second communication device 64 (step 609), the first communication device 63 (step 610) and the node operating the agent node 62 (step 611). The agent node 62 forwards the response signal to the server 61 (step 612). The broadcast path for the response signal can also be the path shown in step 613 and to the server 61 via the agent node 62 (step 614).

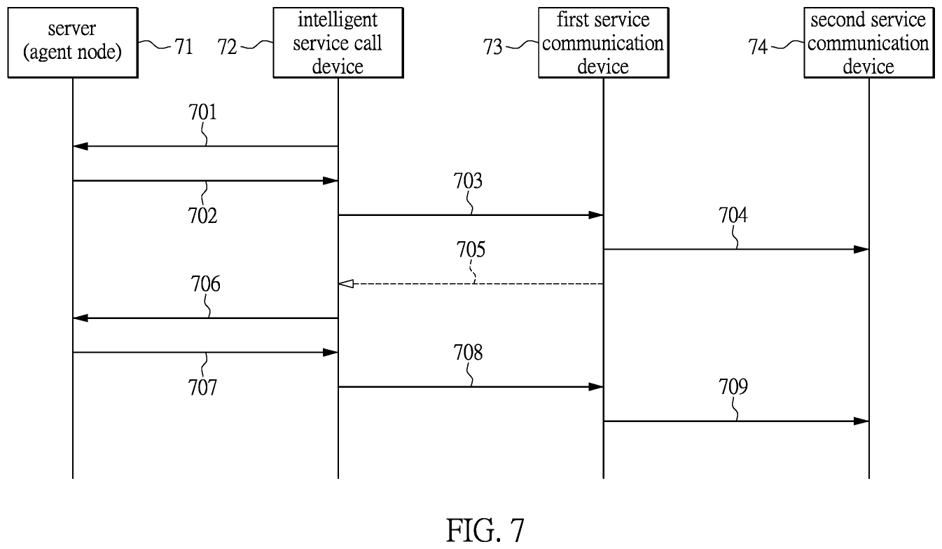

FIG. 7 shows another flow chart describing the communication method according to another embodiment of the disclosure. The server 71 generally transmits and receives signals via an agent node. The server 71, an intelligent service calling device 72, a first service communication device 73 and a second service communication device 74 form a mesh network.

In the beginning, the intelligent service calling device 72 generates a service request signal. The service request signal is broadcasted via a BLE mesh network. The service request signal reaches the server 71 via the agent node (step 701). The server 71 then confirms the information of service location carried by the service request signal. The server 71 also determines a corresponding service personnel and calling information of his service communication device.

The server 71 then generates a service calling signal based on the abovementioned information. The service calling signal is broadcasted to the mesh network via the agent node. In the present example, the service calling signal firstly reaches the node of the intelligent service calling device 72 (step 702), and is broadcasted to the first service communication device 73 (step 703) and the second service communication device 74 (step 704).

When the first service communication device 73 carried by the corresponding service personnel receives the service calling signal, a service location can be recognized. The service personnel then goes to the service location with respect to the intelligent service calling device (step 705). If a distance between the first service communication device 73 and the intelligent service calling device 72 reaches a threshold, the intelligent service calling device 72 generates a service dismissing signal, and the service dismissing signal is broadcasted via the mesh network and to the server 71 (step 706).

When the server 71 receives the service dismissing signal, the server 71 generates a service calling dismissing signal that is broadcasted via the mesh network. The service calling dismissing signal allows the other service personnel to know that the service calling has been dismissed. A broadcast path includes the path to the second service communication device 74 through the intelligent service calling device 72 (step 707), the first service communication device 72 (step 708) and the first service communication device 73 (step 709).

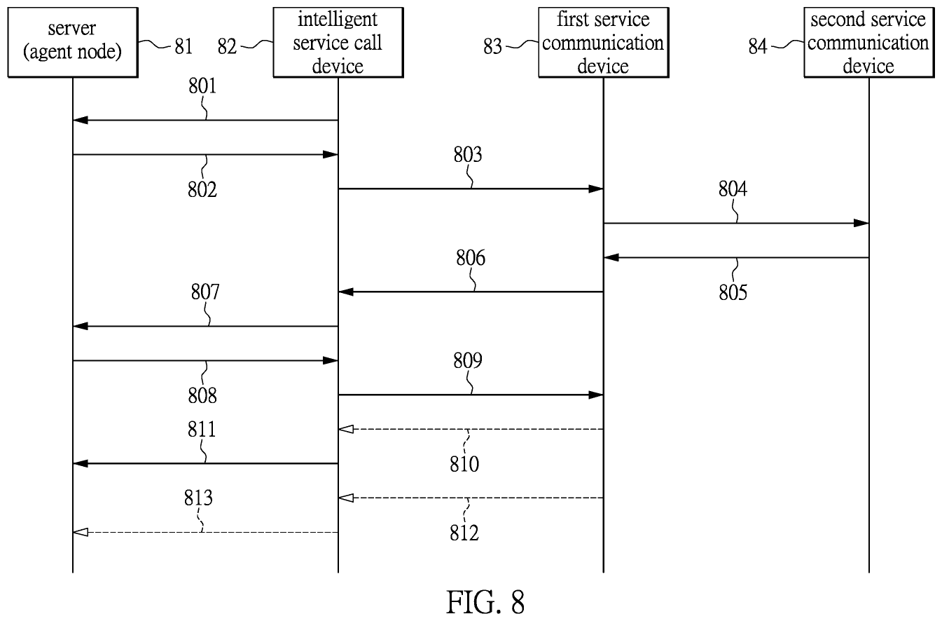

FIG. 8 shows one further flow chart describing the communication method according to one further embodiment of the disclosure.

Similarly, a server 81 (agent node), an intelligent service calling device 82, a first service communication device 83 and a second service communication device 84 form a mesh network, and are communicated with each other under the BLE communication protocol.

The intelligent service calling device 82 firstly generates a service request signal. The service request signal is broadcasted to the server 81 via an agent node (step 801). The server 81 then generates a first service calling signal. The first serving calling signal is broadcasted via the agent node. The first serving calling signal reaches the second communication device 84 (step 804) through the intelligent service calling device 82 (step 802) and the first service communication device 83 (step 803).

In response to the first service calling signal, the second service communication device 84 generates a rejection signal. The rejection signal is broadcasted to the server 81 (step 807) through the first service communication device 83 (step 805) and the intelligent service calling device 82 (step 806).

Therefore, a software sequence operating in the server 81 acquires a service personnel that is next in order and his carried service communication device, e.g. the first service communication device 83. A second service calling signal is generated and broadcasted to the nodes of the mesh network. The second service calling signal is transmitted to the first service communication device 83 (step 809) through the intelligent service calling device 82 (step 808).

In the process, the service personnel carrying the first service communication device 83 goes to a service location that is resolved from the information carried by the service calling signal (step 810). The intelligent service calling device 82 then generates a service dismissing signal when the service personnel arrives at the service location. The service dismissing signal finally reaches the server 81 that is set as the destination of the service dismissing signal (step 811). The service dismissing signal can also be generated by the first service communication device 83, and broadcasted via the network. In the exemplary example, the service dismissing signal is broadcasted to the server 81 (step 813) through the intelligent service calling device 82 (step 812).

It should be noted that the server can be a software sequence operating in one of the terminal devices, but not limited to specific computers or POS. If the server is implemented by a standalone host, this host would connect with the mesh network via the agent node. The server includes a service personnel database that embodies a lookup table. The lookup table records identification information of the intelligent service calling device and its corresponding service location. The lookup table also records calling information with respect to one or more service personnels corresponding to the service location. If the service location corresponds to multiple service personnels, a service order is provided and is recorded in a service personnel database. When calling one of the service personnels, the service personnels can be called one by one according to the service order. The server callings a next service personnel when the server receives a rejection signal or the service calling is timed out. It may be necessary for a supervisor to go to the service location under some specific circumstances. Further, under other circumstances, more than one service personnel can be called at the same time, and the service personnels can decide whether or not to go to the service location for service.

In summation, in the IoT service system with the Bluetooth Low Energy mesh network, the nodes are connected with each other so as to form a mesh network. The node generates the message and forms the packet in compliance with Bluetooth Low Energy communication protocol. The message is broadcasted via the mesh network. The IoT service system is therefore extensible for adapting to a variety of service procedures.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A communication method adapted to an IoT service system that includes one or more intelligent service calling devices and one or more service communication devices of a Bluetooth Low Energy mesh network, wherein the communication method comprises:
one of the intelligent service calling devices generating a service request signal in compliance with a Bluetooth Low Energy communication protocol, wherein the service request signal carries identification information of the intelligent service calling device;
broadcasting the service request network via the Bluetooth Low Energy mesh network;
a server receiving the service request signal and querying a service personnel database based on the identification information for acquiring a service personnel corresponding to the identification information, and generating a service calling signal that carries information with respect to the intelligent service calling device that generates the service request signal;
broadcasting the service calling signal via the Bluetooth Low Energy mesh network, and the service communication devices of the service personnels receiving the service calling signal; and
generating a service dismissing signal when a distance between the service communication device and the intelligent service calling device that generates the service request signal reaches a threshold, and transmitting the service dismissing signal via the Bluetooth Low Energy mesh network to the server.

2. The method according to claim 1, wherein the distance between the service communication device carried by the service personnel and the intelligent service calling device is calculated according to a received signal strength.

3. The method according to claim 1, wherein the service personnel database records service locations corresponding to identification information of the intelligent service calling devices, and the calling information is a communication ID with respect to the service communication device carried by the service personnel.

4. The method according to claim 3, wherein the distance between the service communication device carried by the service personnel and the intelligent service calling device is calculated according to a received signal strength.

5. The method according to claim 3, wherein, when the service location corresponds to multiple service personnels, a service order of the service personnels corresponding to the service location recorded in the service personnel database is provided; when the service communication device of a first service personnel in order generates a rejection signal as he receives the service calling signal according to the service order, the server issues the service calling signal again to a next service personnel in order; and the rejection signal is broadcasted via the Bluetooth Low Energy mesh network.

6. The method according to claim 5, wherein, when the first service personnel in the service order receives the service calling signal, the server starts a timer; if the server does not receive the service dismissing signal when the timer reaches a time threshold, the server re-issues the service calling signal to a next service person in order.

7. The method according to claim 6, wherein the server issues the service calling signal to the service communication devices carried by the service personnels corresponding to the service location; when the server receives the service dismissing signal from one of the service personnels, the server issues a service calling dismissing signal to other service personnels via the Bluetooth Low Energy mesh network.

8. The method according to claim 1, wherein the server joins the Bluetooth Low Energy mesh network through an agent node, and the server receives the service request signal, issues the service calling signal, receives the service dismissing signal and issues the service calling dismissing signal via the agent node.

9. The method according to claim 8, wherein the distance between the service communication device carried by the service personnel and the intelligent service calling device is calculated according to a received signal strength.

10. The method according to claim 9, wherein the service dismissing signal is generated by the intelligent service calling device or the service communication device, and broadcasted to the Bluetooth Low Energy mesh network.

11. An IoT service system with Bluetooth Low Energy mesh network, comprising:
a server;
a plurality of service communication devices carried by a plurality of service personnels, a communication unit of the service communication device generating packets under a Bluetooth Low Energy communication protocol and also supporting a mechanism with short pieces of data and of turning off the circuit while in idle state; and
a plurality of intelligent service calling devices disposed at a plurality of service locations, a communication unit of the intelligent service calling device generating packets under a Bluetooth Low Energy communication protocol and also supporting a mechanism with short pieces of data and of turning off the circuit while in idle state;
wherein the service communication devices and the intelligent service calling devices act as nodes in the Bluetooth Low Energy mesh network, and one of the intelligent service calling devices generates a service request signal in compliance with Bluetooth Low Energy communication protocol, and the service request signal carries identification information of the intelligent service calling device; the service request signal is broadcasted via the Bluetooth Low Energy mesh network;
further, the server receives the service request signal and looks up a service personnel database according to the identification information for obtaining a corresponding service personnel and calling information relating to the service communication device carried by the service personnel so as to form a service calling signal;
still further, the service calling signal is broadcasted via the Bluetooth Low Energy mesh network and received by the service communication device carried by the service person; and
wherein, when a distance between the service communication device and the intelligent service calling device generating the service request signal reaches a threshold, a service dismissing signal is generated and broadcasted via the Bluetooth Low Energy mesh network; the server receives the service dismissing signal.

12. The system according to claim 11, further comprising a service management device connected with the server and joining the Bluetooth Low Energy mesh network through an agent node.

13. The system according to claim 11, wherein the distance between the service communication device carried by the service personnel and the intelligent service calling device is calculated according to a received signal strength.

14. The system according to claim 11, wherein the service personnel database records service locations corresponding to identification information of the intelligent service calling devices, and calling information, and the calling information is a communication ID with respect to the service communication device carried by the service person.

15. The system according to claim 14, wherein the distance between the service communication device carried by the service personnel and the intelligent service calling device is calculated according to a received signal strength.

16. The system according to claim 15, wherein, when the service location corresponds to multiple service personnels, a service order of the service personnels corresponding to the service location recorded in the service personnel database is provided; when the service communication device of a first service personnel in order generates a rejection signal as he receives the service calling signal according to the service order, the server issues the service calling signal again to a next service person in order; and the rejection signal is broadcasted via the Bluetooth Low Energy mesh network.

17. The system according to claim 16, wherein the server issues the service calling signal to the service communication devices carried by the service personnels corresponding to the service location; when the server receives the service dismissing signal from one of the service personnels, the server issues a service calling dismissing signal to other service personnels via the Bluetooth Low Energy mesh network.

18. The system according to claim 11, wherein the server joins the Bluetooth Low Energy mesh network through an agent node, and the server receives the service request signal, issues the service calling signal, receives the service dismissing signal and issues the service calling dismissing signal via the agent node.

19. The system according to claim 18, wherein the distance between the service communication device carried by the service personnel and the intelligent service calling device is calculated according to a received signal strength.

20. The system according to claim 19, wherein the service dismissing signal is generated by the intelligent service calling device or the service communication device, and is broadcasted to the Bluetooth Low Energy mesh network.
